(19) United States
(12) Patent Application Publication
(10) Pub. No.: US 2005/0239476 A1
(43) Pub. Date: Oct. 27, 2005

(54) Method and system for providing location information of a mobile station

(76) Inventors: Arvind Betrabet, Murphy, TX (US); Mahbuhul Alam, McKinney, TX (US); Ghassan Naim, Garland, TX (US); Andrew Silver, Dallas, TX (US); Seshagiri R. Madhavapeddy, Richardson, TX (US)

Correspondence Address: Jessica W. Smith;Alcatel USA, Intellectual Property Department, 3400 W. Plano Parkway, MS LEGL2, Plano, TX, 75075, US

(21) Appl. No.: 10/515,789

(22) PCT Filed: May 30, 2003
(86) PCT No.: PCT/US03/17082

§ 371 Date: Nov. 24, 2004

Related U.S. Application Data
(60) Provisional application No. 60/384,624, filed on May 31, 2002.

(51) Int. Cl. H04Q 7/20

(52) U.S. Cl. 455/456.1; 455/456.6

(57) ABSTRACT

The present disclosure provides a method and system (100) for obtaining the geographical position (latitude, longitude) of mobile station (MS) such as a CDMA 1x handheld mobile device (102) when it is in a packet mode session. The disclosed method and system allows the mobile station (102) to transparently switch from data to voice session tentatively, determines the geographical position thereof, and then switches back to the packet data mode and resume the data session.

### CROSS REFERENCE TO RELATED APPLICATION

This application claims the benefit of the filing date of U.S. provisional patent application Ser. No. 60/384,624, filed on May 131, 2002, the disclosure of which is incorporated herein by reference.

### BACKGROUND OF THE INVENTION

This present invention relates generally to wireless voice and data communications, and more particularly, to a system and method for providing location information of a mobile station (MS) such as a CDMA 1X mobile device while it is in a packet mode session.

In the conventional art, in order to determine the geographical position of a mobile station, the MS to be in a voice mode session. What is needed is a method and system to allow the device to provide its location information when it is in a packet data mode session.

### SUMMARY OF THE INVENTION

The present disclosure provides a method and system for obtaining the geographical position of a mobile station such as a CDMA 1X handheld device, including its latitude and longitude, when the mobile handset is in packet data mode session. The disclosed method and system makes the MS switch tentatively from the packet mode to the voice mode, determines the geographical position thereof, and once the location information is retrieved, switches back to the packet mode session to resume the suspended packet session.

The present disclosure introduces a minimum amount of delay in the service to provide mobile location information. Moreover, the present disclosure also provides a capability to the network to extract the geographical location while the mobile is in a data session seamlessly without user interaction. This creates transparency to the user.

Additionally, the present invention discloses a solution to the problem by introducing a new network entity without introducing any changes to any other existing network entities.

Additionally, the present invention discloses a solution that does not require any changes to existing standards based on core network infrastructure and handheld mobile devices.

### BRIEF DESCRIPTION OF THE DRAWINGS

FIG. 1 illustrates the network architecture for a CDMA 1X technology where a mobile is shown operating in its serving network.

FIG. 2 to FIG. 6, illustrate the message flow for providing location information of a mobile station operating in a CDMA 1X network.

### DESCRIPTION OF THE PREFERRED EMBODIMENT

For the purposes of illustrating the method and system described in the present disclosure, various acronyms are used, the definitions of which are listed below:

| | |
|---|---|
| BSC | Base Station Center |
| BSS | Base Station System |
| BTS | Base station Transceiver System |
| FA | Foreign Agent |
| GMSC | Gateway MSC |
| GSM | Global System for Mobile communications |
| HA | Home Agent |
| HLR | Home Location Register |
| IP | Internet Protocol |
| IS41 | Wireless Network conforming to the IS41 standard |
| ISDN | Integrated Services Digital Network |
| ISUP | ISDN User Part |
| MIP | Mobile IP |
| MPC | Mobile Positioning Centre |
| MSC | Mobile Switching Centre |
| PCF | Packet Control Function |
| PDE | Position Determination Entity |
| PDSN | Packet Data Serving Network |
| PSTN | Public Switch Telephone Network |
| SMS-C | Short Message Service Centre |
| SS7 | Signalling System No.7 |
| T1 | Digital communication line that uses tine division multiplexing |
| | with an overall transmission rate |
| | of 1.544 Million bits per second |
| TCP/IP | Transmission Control Protocol/Internet Protocol |

The present disclosure is described below with several examples. It is understood, however, that the examples are not necessarily limitations to the present disclosure, but are used to describe embodiments of operation.

The present disclosure can be described by the embodiments given below. It is understood, however, that the embodiments below are not necessarily limitations to the present disclosure, but are used to describe a typical implementation of the invention.

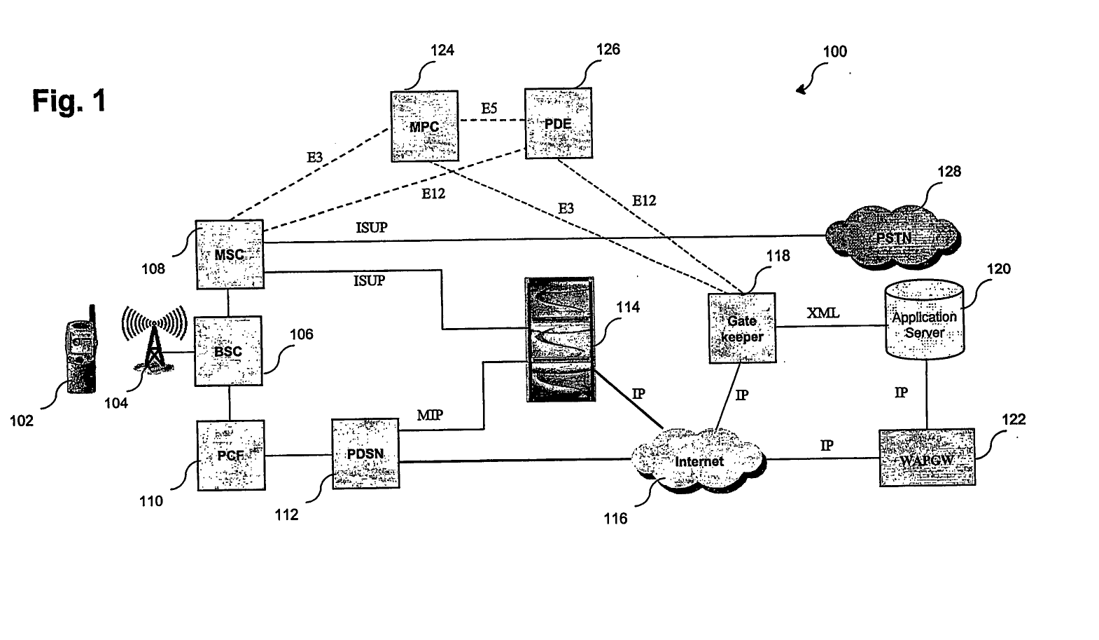

FIG. 1 illustrates an exemplary network architecture 100 for a CDMA 1X technology where a mobile 102 is shown in communication with the network 100 through a base station transceiver system “BTS” 104. The BTS 104 may be in communication with a base station center “BSC” 106, which in turn may be in communication with a mobile switching center “MSC” 108 and a packet control function “PCF” 110. The PCF 110 may be in communication with a packet data serving network “PDSN” 112. In an exemplary embodiment, a location service node “LSN” 114 may be in communication with MSC 108 using the ISDN user part or “ISUP” signaling protocol. Similarly, the LSN 114 may also be connected to the PDSN 112 using the mobile IP or “MIP” protocol. The LSN 114 is in communication with a public network, such as the Internet 116 using a standard protocol, such as Internet Protocol “IP.” A service gateway node or Gate Keeper “GK” 118 is also in communication with the Internet 116 via IP. Thus, the LSN 114 and the GK 118 may communicate through the Internet 116 using an Internet specification, such as the XML.

The GK 118 may be in communication with one or more application servers, such as application server 120. The application server 120 may communicate with the GK 118 using the XML specification. The application server 120 may also be in communication with a Wireless Access Protocol Gateway “WAPGW” 122, which may also be in communication with the Internet using IP.

In an exemplary embodiment, the MSC 108 may also be in communication with a Mobile Positioning Center “MPC” 124, using an E3 interface; a Position Determination Entity “PDE” 126 using an E12 interface, and a Public Switched Telephone Network “PSTN” 128 using an ISUP protocol. The MPC 124 and the PDE 126 may be in communication with the GK 118 using E3 and E12 protocols, respectively.

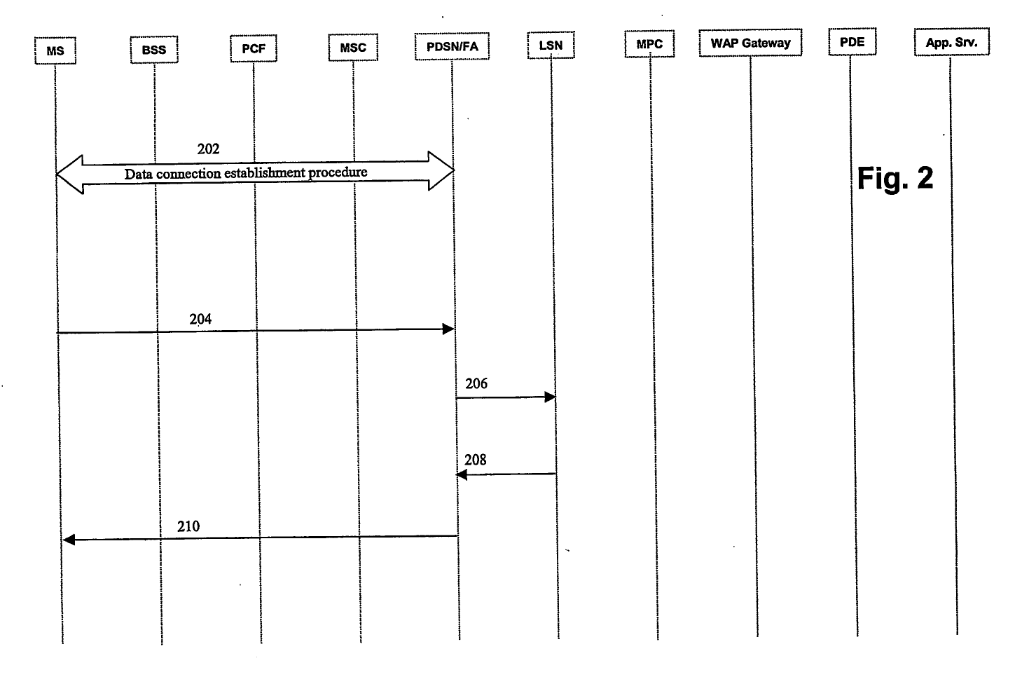

FIG. 2 illustrates one aspect of a call flow procedure to activate a data call In step 202, a standard CDMA 1X procedure is implemented to establish a data channel between the mobile station 102 and a foreign agent operating in the PDSN 112. Once the data channel is established, in step 204, the mobile station 102 sends a Mobile IP (MIP) registration message to the PDSN, which, in step 206, forwards the MIP Registration Request to the LSN node 114. In the illustrative embodiment, the LSN 114 analyses the request and approves based on the mobile information sent in the message. The LSN node 114 may approve the request by sending a MIP registration Reply in step 208 to the PDSN, which in turn sends a MIP Registration Reply back to the MS in step 210.

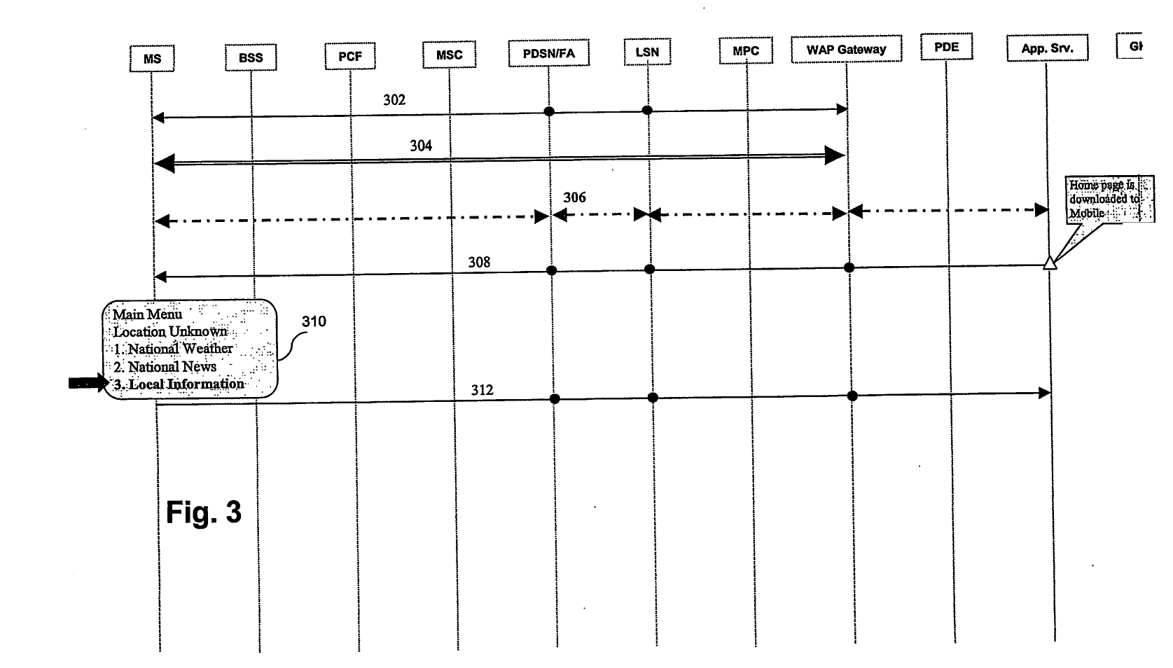

Turning now to FIG. 3, there is illustrated a continuation of the procedure presented in FIG. 2. Once the data path has been established as previously discussed, in step 302, the mobile station initiates a WAP session with the network according to methods known in the art Once the WAP Session has been established (step 304), a data connection 306 between the Application Server and the mobile station may be established. The Application Server may then download WAP pages to the mobile station, such as a WAP home page. As an illustrative example, the WAP page may contain a menu 308 containing user selections such as: (1) National Weather, (2) National News, and (3) Local Information. Upon selecting “Local Information” from the menu, the mobile handset sends this link request to the application server in step 310.

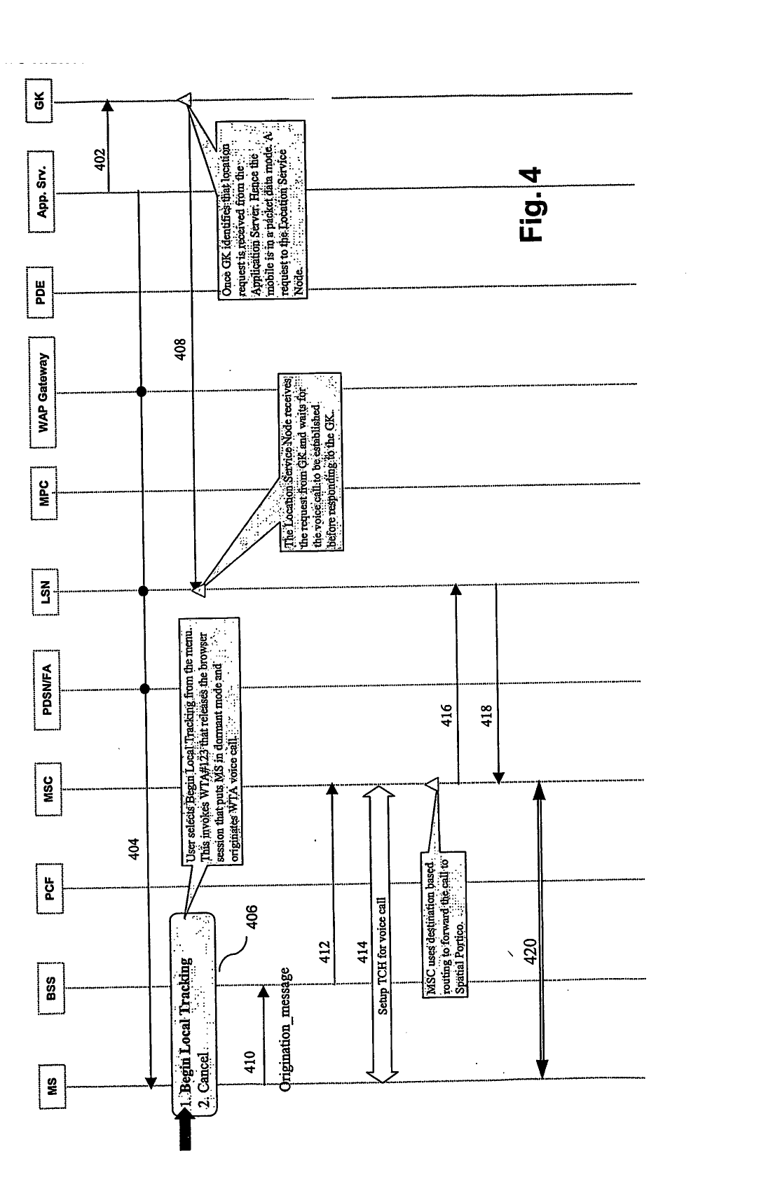

Continuing the call flow in FIG. 4, the application server sends a Locate Request message, such as an XML: GPS Locate Request 402 to the Gate Keeper. In step 404, the application server sends a new menu to the mobile station. The new menu 406 may include a WTA link indicating to the mobile user to confirm the decision by selecting “Begin Local Tracking” or “Cancel” the operation. Once the GK identifies that the location request is received from the Application Server, the GK assumes the mobile is in a packet data mode and GK sends a request, such as an XML GPS locate request 408 to the LSN 118. The LSN receives the request from GK and waits for the voice call to be established before responding to the GK. At the mobile station, upon the user selecting “Begin Local Tracking” from the menu 406, an origination message 410, such as WTA#123 is sent to the BSS, which releases the browser session and puts MS in dormant mode. At the same time, the WTA link originates WTA voice call to the destination number “#123”, used herein as an example. The mobile originating voice request 412 reaches the serving MSC, which in this example may be a CM Service Request [Service Option=Voice] message. Such a request starts a radio channel establishment procedure (step 414). Once the traffic channel has been reserved, the MSC uses destination based routing to forward the call to the LSN by sending, for instance, an ISUP: IAM message 416. In step 418, the LSN then responds by sending an ISUP: ACM and ANM messages. At this point, the voice call has been established (step 420) and the mobile is in a packet dormant state.

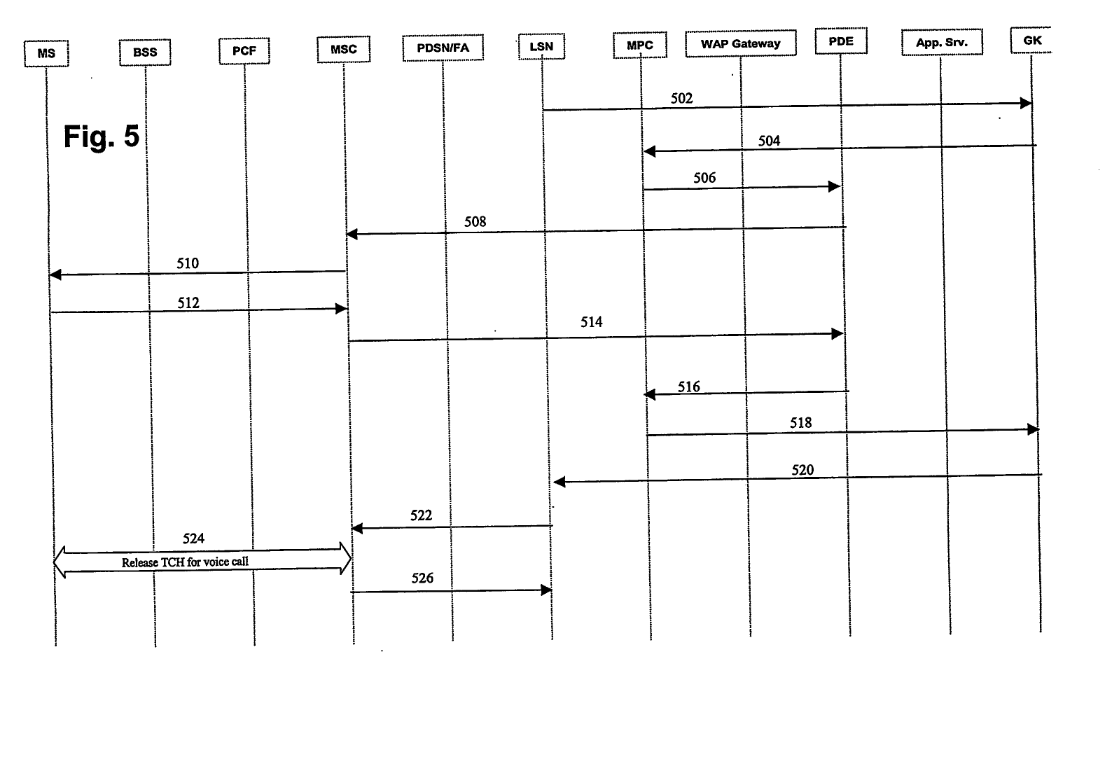

Continuing the call flow in FIG. 5, the LSN sends a request 502 to GK for mobile location, which could be in the form of an XML: GPS locate req [Perform GPS locate]. Because the mobile is now out of the data mode, the MSC can perform the location information query. Thus, the GK sends a ORREQ message 504 to MPC, which in response, sends a GPOSREQ 506 to the PDE node. The PDE then sends a SMDPP message 508, such as a SMDPP[SRVIND, ACTCODE, SMS-bearer-data] to the MSC. In response, the MSC requests the mobile for its location information by sending a request 510, such as a DATABURST message to the mobile station. In response, the mobile station sends a response message 512, such as a data burst (IS-801) message. The MSC then sends to PDE a SMDPP message 514, such as smdpp[SMS-bearer-data], which may contain an SMS message having the location information. The PDE may extract the location information and then send a response message 516, such as a GPOSREQ [PSOINFO] message to the MPC. The MPC then forwards the location information to GK in a response message 518, which may be in the form of a ORREQ [GEOPOS] message. The GK then sends the location information to ISN using a message 520, such as an XML: GPS locate res[Location Information] message. The LSN then releases the voice call for the mobile station by sending a message 522, such as a ISUP: REL message to the MSC. The MSC, in step 524, then releases all radio resources for that mobile and responds to the LSN with a message 526, which may be in the form of an ISUP RLC message.

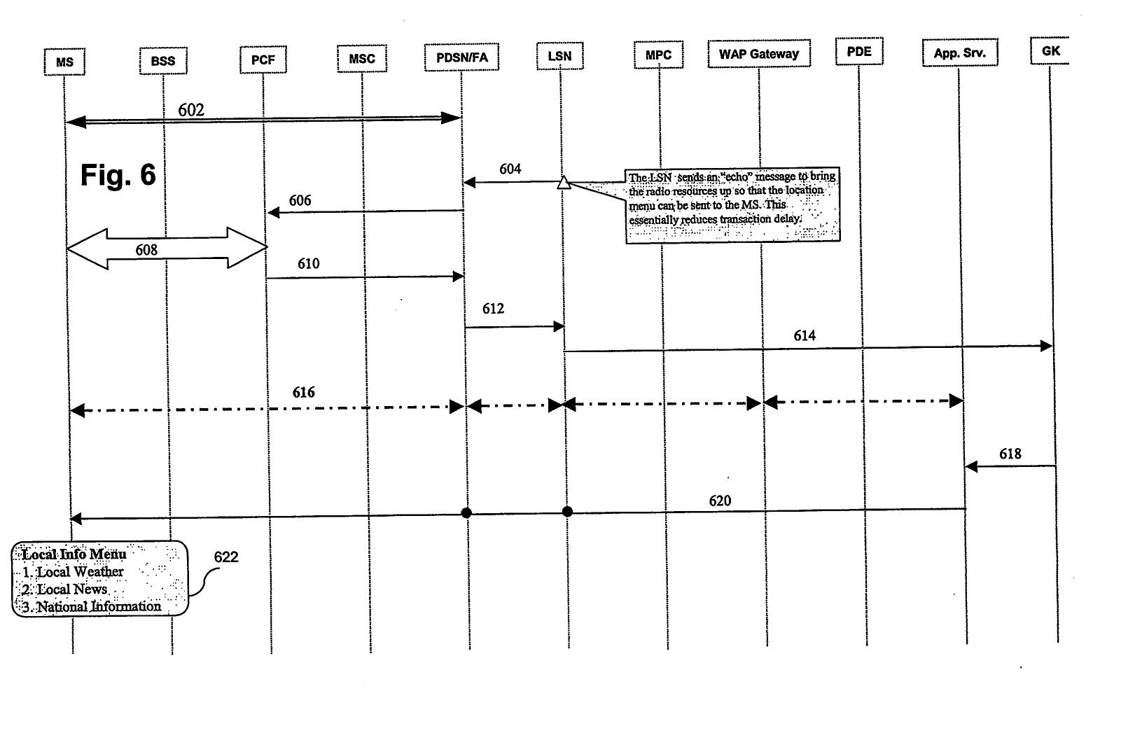

Continuing the call flow in FIG. 6, step 602 indicates that the mobile is currently in a packet dormant state. In step 604, the LSN sends an “echo” message to the PDSN, in the form of a ICMP: Echo Request message. In step 606, this echo message is forwarded to the PCF. Once the ICMP: Echo Request message is received by the PCF, a mobile paging and radio setup procedure is triggered with the mobile in step 608. The paging procedure allows the mobile to operate back in the packet data mode, and the data connection is resumed with the application server (as indicated by data connection 616). An echo reply message 610, such as an ICMP: Echo Reply message is sent to the PDSN. In step 612, the PDSN forwards the echo reply message to the LSN. When the echo reply message is received by the ISN, the LSN sends a GPS locate Response 614, in the form of an XML: GPS locate res [location information] message, to the GK as a response to the request 408 sent to the ISN previously (FIG. 4). The GK then forwards the mobile location information in step 618, using for instance an XML: GPS Locate res [Location Info] message, to the application server. The application server then extracts the information and creates a menu 622 corresponding to the local information, and, in step 620, sends the local information menu to the mobile.

The above disclosure provides example embodiments for implementing the disclosure. However, specific examples and processes are described herein to help clarify the disclosure. These are, of course, merely examples and are not intended to limit the disclosure from that described in the claims. For instance, even though a CDMA 1X network is used to describe the disclosure, the present patent also applies to any network that adopts a technology that does not allow the flexibility of extracting the geographical location when the mobile is involved in a packet data session.

Additionally, even though the present patent was described using the concept where the Gate Keeper requests the location information from the network, the invention still applies when the ISN requests the location information after it switches the mobile into a voice channel. Similar to the described embodiment, the LSN may switch the MS back to its suspended data session after the location information is determined. In this alternative embodiment, the Gate Keeper module may still be involved in the complete procedure, but it does not perform the location determination function.

The present disclosure as described above thus provides an economical and effective solution in detecting the geographical location of a mobile station operating in a packet data mode without introducing any changes to other network entity nodes and providing the solution with complete transparency to the mobile user and all network entities.

It will also be understood by those having skill in the art that one or more (including all) of the elements/steps of the present disclosure may be implemented using software to develop the spatial wireless logic in a given network entity which will then be deployed in a telecommunication network at appropriate locations with the proper connections.

Furthermore, while the disclosure has been particularly shown and described with reference to the preferred embodiment thereof, it will be understood by those skilled in the art that various changes in form and detail may be made therein without departing from the spirit and scope of the disclosure, as set forth in the following claims.

1. A method for obtaining the geographic position of a mobile station when the mobile station is in a packet data mode, the method comprising:
switching the mobile from the packet data mode to a voice mode,
determining the geographic position of the mobile station,
sending the geographic position to the mobile station, and
switching the mobile station from the voice mode to the packet mode.

2. The method of claim 1 wherein the switching the mobile from the packet data mode to the voice mode comprises:
placing the mobile station into a dormant mode,
originating a WTA voice call, and
routing the call to a location service node.

3. The method of claim 1 wherein the determining comprises:
sending a data burst message to the mobile station, and
receiving a data burst response.

4. The method of claim 1 further comprising:
sending a short message service message to a MSC requesting the geographical position of the mobile station,
receiving a short message service message from the MSC containing the geographical position of the mobile station.

5. The method of claim 1 further comprising sending a location request to a service gateway node and receiving geographic information in response to the request.

6. The method of claim 1 further comprising:
sending a menu of user selectors to the mobile station, wherein one of the selectors indicates a request for geographic information, and
receiving an indicator indicating a request for geographic information.

7. A network node in a wireless network, the node comprising:
a means for allowing a data connection between a mobile station and an application server,
a means for receiving a location request from a service gateway,
a means for receiving a voice call from the mobile station,
a means for sending a location request message to a service gateway,
a means for receiving location information from the service gateway,
a means for releasing the voice call,
a means for sending the location information to the service gateway, and
a means for allowing a data connection between an application server and a mobile station.

8. The network node of claim 7 further comprising a means for establishing radio resources so that a location menu can be sent to the mobile station.

9. The network node of claim 7 wherein the means for sending a location request comprises an XML GPS location request message.

10. The network node of claim 7 wherein the means for receiving the location information comprises an receiving an XML GPS location Information message.

11. The network node of claim 8 wherein the means for establishing radio resources comprises sending an ICMP Echo Request message and receiving an ICMP Echo Reply message.

12. The network node of claim 7 wherein the means for releasing the voice call comprises sending an ISUP release message.

13. An application server comprising:
a means for establishing a data connection with a mobile station in a wireless network,
a means for sending a plurality of selectors to the mobile station wherein one of the selectors indicates a request for location information,
a means for receiving a request for location information from the mobile station,
a means for sending a location request to a service gateway,
a means for receiving location information from the service gateway, and
a means for sending the location information to the mobile station.

14. The application server of claim 13 further comprising a means for sending a menu with location information to the mobile station.

15. A service gateway node in a wireless network, the service gateway node comprising:
a means for receiving a location request message from an application server,
a means for sending a location request message to a location service node,
a means for receiving location information from the location service node, and
a means for sending a location information to the application server.

16. The service gateway of claim 15 wherein the means for receiving a location request message comprises receiving an XML GPS locate request message.

17. The service gateway of claim 15 wherein the means for sending a location request message comprises sending an XML GPS locate request message.

18. The service gateway of claim 15 wherein the means for receiving location information comprises receiving an XML GPS locate res message.

19. The service gateway of claim 15 wherein the means for sending a location request message comprises sending an XML GPS locate res message.
